(19) United States
(12) Patent Application Publication
(10) Pub. No.: US 2003/0106761 A1
(43) Pub. Date: Jun. 12, 2003

(54) Shape memory alloy wrap spring clutch

(76) Inventor: William Morris Taylor, Houston, TX (US)

Correspondence Address: CONLEY ROSE, P.C., P. O. BOX 3267, HOUSTON, TX, 77253-3267, US

(21) Appl. No.: 10/017,284

(22) Filed: Dec. 7, 2001

(51) Int. Cl. F16D 13/04

(52) U.S. Cl. 192/41 R

(57) ABSTRACT

A wrap spring clutch having a spring constructed of a shape memory alloy. This wrap spring clutch operates in the same manner as any other basic wrap spring clutch except that the spring expands and releases when the spring is heated to a predetermined temperature. The heat may be applied to the spring through external sources or by an electrical current being applied to the spring.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to methods and apparatus for wrap spring clutches. More precisely, the present invention relates to the novel application of using a shape memory alloy for the spring component of a wrap spring clutch. Yet more specifically, the present invention relates to using a spring constructed of a shape memory alloy in a wrap spring clutch assembly so that the energization of the spring can be controlled by temperature; wherein the assembly operates in a non-energized, normal mode, wherein the relative rotational movement of two shafts is restricted, and in an energized, released mode, wherein the relative motion is not restricted.

Shape memory alloys refer generally to a group of metallic materials that demonstrate the ability to return to some previously defined shape when subjected to the appropriate thermal excursion. Generally, these materials can be plastically deformed at some relatively low temperature, and upon exposure to some higher temperature will return to their shape prior to the deformation. Materials that exhibit shape memory effects only upon heating are referred to as having a one-way shape memory. Materials that also undergo a change in shape upon recooling are referred to as having a two-way shape memory. The most common of the shape memory alloys is Nitinol, which is an alloy comprising primarily nickel and titanium. Other elements can be added to adjust or enhance the material properties.

One-way shape memory effect describes the process of restoring the original shape of a plastically deformed piece of material by heating it. When the piece is made, it is formed to a desired shape during the heat treatment process. While the piece is below its transformation temperature, the material is in a soft martensitic form and can easily be plastically deformed. Heating the piece to the transformation temperature converts the material to its high strength, austenitic form, which returns the sample to its original desired shape. The piece can be cooled and the deformation and restoration steps performed multiple times. The temperatures at which this transformation takes place can be closely controlled through manipulation of the alloy and heat treatment. The shape memory effect is repeatable and can typically result in up to 8% strain recovery.

Two-way shape memory effect is similar to the one-way process described above but the material assumes one shape when heated and another shape when cooled. This behavior is accomplished through the same mechanisms as one-way deformation but involves greater difficulty in production and involves a more complex series of heat treatment and manufacturing processes. One disadvantage of a two-way memory effect material is that when transforming at a high temperature it produces less force than a comparable one-way material transforming at the same temperature and when transforming at a lower temperature, even less force is produced. Therefore, although a two-way effect material can have two predetermined shapes it produces substantially less force than a one-way material transforming at a comparable temperature.

Wrap spring clutches are well known in a variety of forms and are used in a variety of applications. In its simplest embodiment, the basic operation of many wrap spring clutch designs involves utilizing a spring coil surrounding two shafts to transfer torque from one shaft to the other in one direction only. As shown in FIG. 1, the basic wrap spring clutch comprises an input hub 12, an output hub 14, and a spring 16. The spring 16 has an inside diameter that is close to or slightly smaller than the outside diameter of the two hubs.

When the input hub 12 rotates in the direction of the spring winding 18, the spring 16 wraps tightly down on the two hubs 12, 14 and positively engages the hubs allowing transmission of torque. When the input hub 12 rotates in the direction opposite the spring winding 18, the spring 16 loosens and allows the hubs 12, 14 to rotate freely. This free rotation of the hubs is known as free-wheeling or over-running. The spring 16 may also have a control tang 20 that when pushed in a direction opposite the spring winding 18, releases the spring 16 and allows freewheeling. The basic wrap spring clutch is useful because it provides a simple and robust clutch/brake design that offers almost instantaneous engagement and disengagement.

While the simplest embodiment of a wrap spring clutch allows the transmission of torque in only one direction, wrap spring clutches are available that permit transfer of torque in both directions and freewheeling in both directions. These bidirectional wrap spring clutches are considerably more complex than the basic embodiment described above.

Wrap spring clutches are currently being used in rotary valve actuators to control the movement of the valve. Many of these type valves used in industry are fail-safe close valves meaning that the valve is biased to the closed position and must be kept open by fluid pressure. In one application, the wrap spring clutch holds a rotary actuator in the open position. An electric solenoid is connected to a control tang on the spring and arranged so that the solenoid will pull the tang and release the spring if electrical power is lost. Therefore, if electrical power is lost, the solenoid will pull the tang to release the spring, which allows the rotary actuator to return to the fail-safe, closed position.

The present invention is directed to improved methods and apparatus for the design and use of wrap spring clutches.

### SUMMARY OF THE INVENTION

The present invention relates to methods and apparatus for an improvement to the design of wrap spring clutches by taking advantage of the unique properties of shape memory alloys. In one embodiment the spring of a wrap spring clutch is constructed from a shape memory alloy. This wrap spring clutch operates in the same manner as any other basic wrap spring clutch except that the spring expands and releases when an electrical current applied to the spring to produce resistance heating or released from the spring allowing it to cool. This embodiment finds utility in providing less complex methods and apparatus for releasing a wrap spring clutch by using an electrical signal.

Another object of the present invention is to provide a simple, reliable, fail-safe mechanism that actuates in response to environmental heating. In another embodiment of the present invention he spring relies on an increase in ambient air temperature (as would be experienced in a fire) to release the spring and allow freewheeling operation.

### BRIEF DESCRIPTION OF THE DRAWINGS

For a more detailed understanding of the preferred embodiments, reference is made to the accompanying Figures, wherein:

FIG. 1 is an isometric view of a prior art wrap spring clutch;

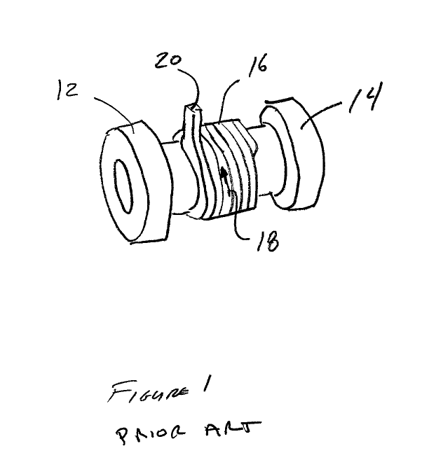

FIG. 2 is a cross-sectional, isometric view of a wrap spring clutch in accordance with the one embodiment of the present invention;

FIG. 3 is a cross-sectional, isometric view of a wrap spring clutch in accordance with another embodiment of the present invention;

FIG. 4 is a cross-sectional, isometric view of a wrap spring clutch in accordance with yet another embodiment of the present invention; and

FIG. 5 is a cross-sectional view of a valve using a wrap spring clutch.

### DETAILED DESCRIPTION OF THE PREFERRED EMBODIMENTS

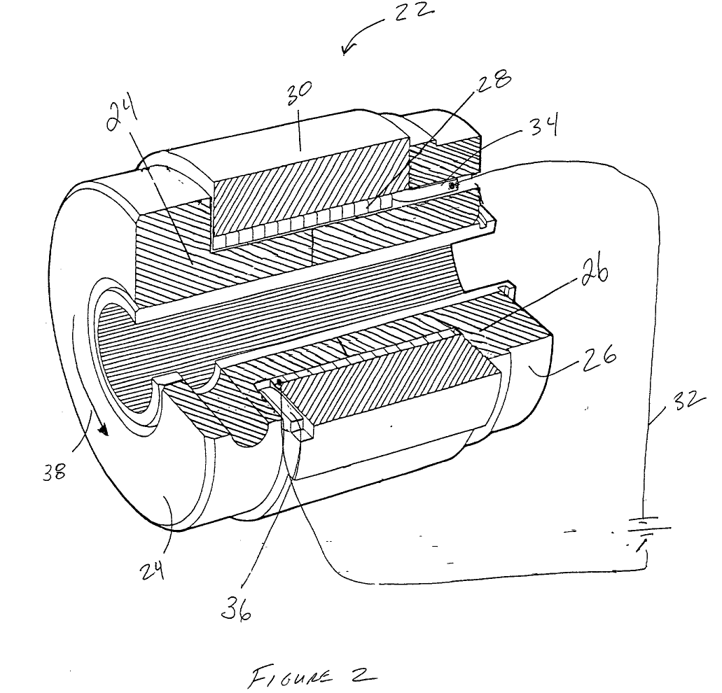

Referring initially to FIG. 2, there is depicted a simple wrap spring clutch mechanism 22. The wrap spring clutch 22 comprises an input hub 24, an output hub 26, a spring 28, a control collar 30, and an electrical circuit 32. The input hub 24 and output hub 26 are arranged coaxially. Spring 28 is circumferentially around both hubs 24, 26 and inside control collar 30. Electrical circuit 32 is attached to each end 34, 36 of spring 28.

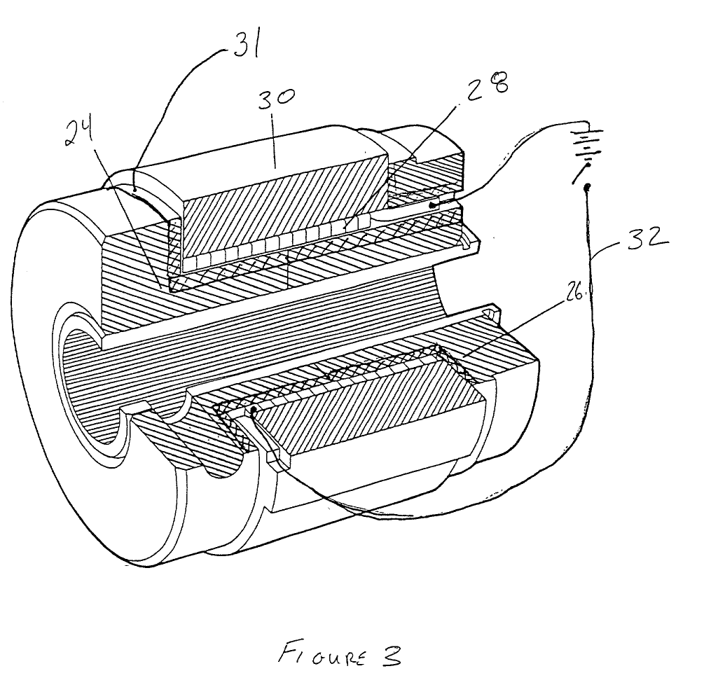

Spring 28 is a cylindrical helical spring preferably having a rectangular cross-section and constructed of a shape memory alloy, preferably Nitinol. Hubs 24, 26 and control collar 30 are preferably constructed of a non-conductive material. Alternatively, as shown in FIG. 3, hubs 24, 26 and the control collar 30 can be constructed of a metallic, conductive material as long as a nonconductive material 31 is placed so as to electrically isolate the spring 28 from any conductive components. In FIG. 3, metallic hubs 24, 26, are isolated from the spring 28 by non-conductive material 31, and a control collar 30 of a non-conductive material.

Referring again to FIG. 2, spring 28 preferably fits snugly around the outer diameter of the hubs 24, 26. The ends 34, 36 of spring 28 are restrained by the output hub 26 and the control collar 30, respectively. Control collar 30 fits around spring 28 and maintains the position of spring 28 with respect to the hubs 24, 26, while allowing the spring 28 to expand sufficiently to allow over-running, or free-wheeling, in both directions. The spring 28 is formed of a shape memory alloy and constructed so that when heated to a certain temperature, the diameter of the spring 28 expands.

When electrical circuit 32 is not energized, i.e. no electrical current is flowing, the assembly operates as a typical wrap spring clutch. When the input hub 24 is rotated in the direction of arrow 38, the spring 28 constricts around the circumference of hubs 24, 26 locking the two hubs together so that torque may be transmitted between them. When input hub 24 is rotated in the opposite direction, the spring 28 expands slightly and allows the input hub 24 to turn independently of the output hub 26.

When electrical circuit 32 is energized, i.e. electrical current is flowing, the spring 28 increases in temperature because of the inherent resistance of the material. Once the temperature reaches a predetermined level, the spring 28 returns to its preformed, slightly expanded condition. Once the predetermined temperature is reached, the spring 28 will change shape rapidly and with great force. The force exerted by spring 28 when expanding, is sufficient to move the spring 28 even under maximum torsional load from the hubs 24, 26. Once the spring 28 expands, both hubs 24, 26 are free to rotate independently of each other, also known as overrunning or freewheeling.

When using a one-way shape memory alloy, the spring is returned to its non-energized position by the movement of the hubs. This occurs because the amount of return deformation allowed is very small and limited by the control collar 30. The control collar 30 thus maintains the spring 28 in a position so that it is returned to the non-energized position when the electrical current is removed.

Although the above described embodiment uses a one-way shape memory alloy, it is also contemplated that a two-way shape memory alloy may be used giving additional flexibility to the arrangement and operation of the clutch. Using a two-way alloy, no assistance is needed from the control collar 30 to retain the spring 28 or return it to its non-energized position. It is also possible to manufacture the spring 28 so that, in the non-energized mode, the clutch can free-wheel in both directions and when the spring 28 is heated and in the energized mode, the clutch operates normally.

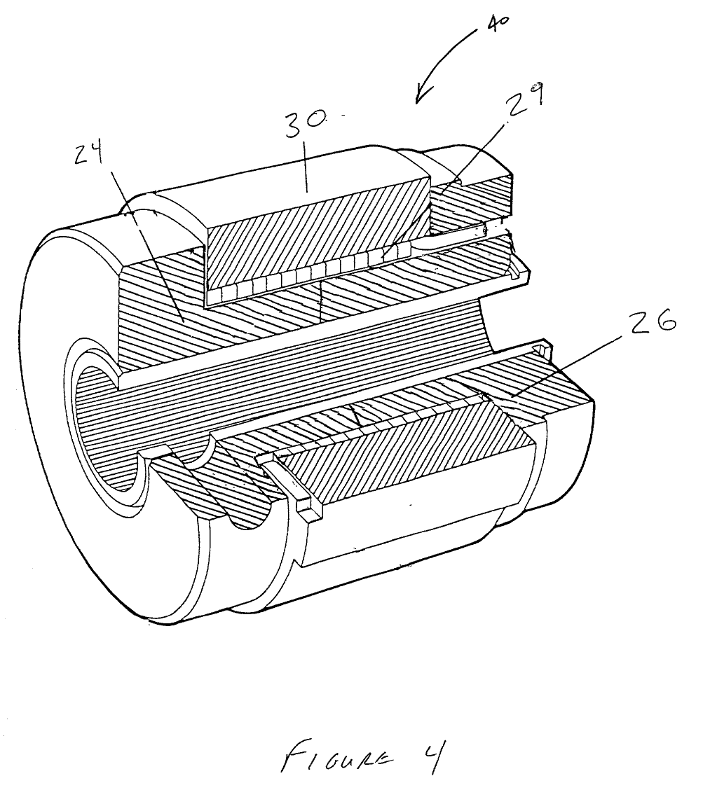

Another embodiment of the present invention is shown in FIG. 4. This embodiment of a wrap spring clutch 40 is similar to the embodiment shown in FIG. 3 and described above except that this embodiment does not include an electrical circuit. The clutch 40 of FIG. 4 comprises metallic hubs 24, 26, spring 29, and a control collar 30. Because there is no electrical circuit, all of the components can be constructed from metallic, conductive materials. This embodiment operates as a simple wrap spring clutch and finds particular utility as a safety release. The wrap spring clutch 40 can be used to hold a fail-safe close valve in the open position. Because the spring 29 is constructed of a shape memory alloy, it will expand if heated to a sufficient temperature. Therefore, the wrap spring clutch 40 will maintain the valve in an open position and in the event of fire, the heat of the fire will cause the spring to expand, releasing the clutch 40 and allowing the valve to close. Alternatively, the clutch 40 could hold a valve closed, for example a valve supplying a sprinkler system, and open the valve in response to an increase in heat.

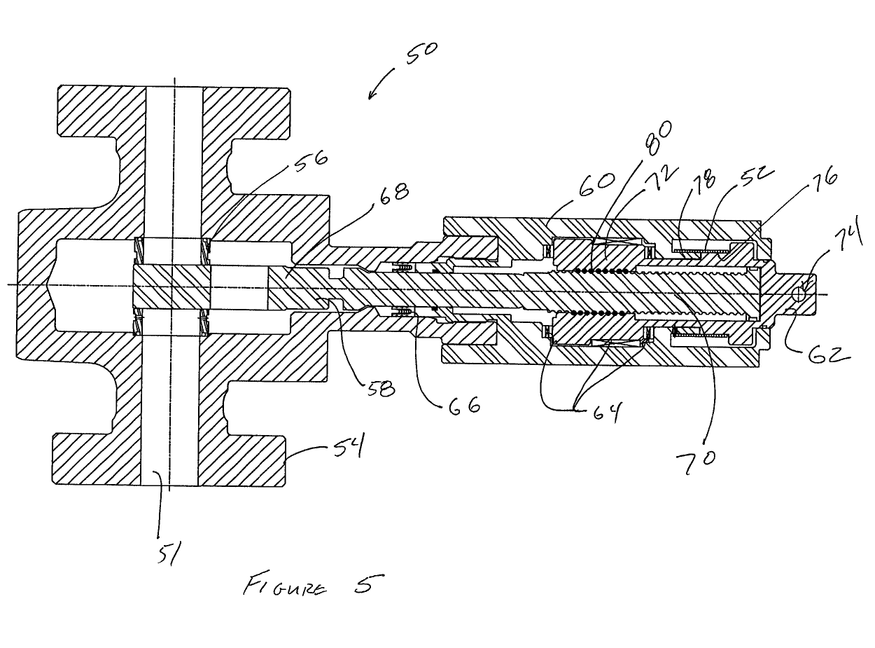

FIG. 5 shows a schematic view of a valve 50 incorporating a wrap spring clutch 52 having a spring constructed of a shape memory alloy. Valve 50 also comprises a valve body 54, seat 56, gate 58, actuator housing 60, actuator 62, bearings 64, and seals 66. Gate 58 comprises a sealing portion 68 and a ball-screw shaft portion 70. Sealing portion 68 acts with seat 56 to seal flowbore 51 in a first position and allows flow through the flowbore in a second position (not shown). Ball-screw shaft portion 70 makes up the shaft of a ball-screw, wherein the ball-screw nut portion 72 is comprised within the actuator 62. Actuator 62 further comprises a torque connection 74 and a hub portion 76. Actuator housing 60 is attached to valve body 54, maintains seal 66 in place and comprises a hub portion 78.

In the closed position, gate 58 and seat 56 create a seal that prohibits flow through the flowbore 51. To open the valve 50, actuator 62 is rotated in a clockwise direction causing gate 58 to move linearly and moving the sealing portion 68 of the gate into the open position. Wrap spring clutch 52 is arranged so as to allow clockwise rotation of the actuator 62. Valve body 54 and seat 56 are arranged so that the pressure within the flowbore 51 and valve body 54 creates a force on the gate 58 that will bias the gate to the closed position.

The ball-screw shaft and nut 70, 72 are designed so that torque is converted to linear force at very high efficiencies. The shaft and nut 70, 72 are threaded with ball bearing races. When the shaft and nut 70, 72 are assembled with ball bearings 80, the connection between the shaft and nut has very little friction. This, combined with the use of bearings 64 allows the bias force created by the pressure within the valve body 54 to close the valve. The closing of the valve is resisted by the wrap spring clutch 52 that will not permit the actuator 62 to rotate in the counter-clockwise direction.

Preferably, a valve 50 of this type is placed in the open position during normal operation. If a fire were to occur in the vicinity of the valve, the spring of the wrap spring clutch 52 will expand with increasing temperature and the valve would be allowed to close. Thus, there is provided a valve that will close if the environmental temperature increases to a predetermined level without the need for any outside actuation or complex control system.

The use of memory shape alloy springs in wrap spring clutches provides a simple, robust design that has the advantages of a wrap spring clutch while providing a simple, effective method for engaging and/or disengaging the mechanism. Wrap spring clutches constructed in accordance with the present invention can be used in any application where wrap spring clutches are currently used and any application where control of a rotating member is required.

The embodiments set forth herein are merely illustrative and do not limit the scope of the invention or the details therein. For example, while it is preferred that the spring be constructed of Nitinol, any material having shape memory alloy properties may be used. It will be appreciated that many other modifications and improvements to the disclosure herein may be made without departing from the scope of the invention or the inventive concepts herein disclosed. Because many varying and different embodiments may be made within the scope of the inventive concept herein taught, including equivalent structures or materials hereafter thought of, and because many modifications may be made in the embodiments herein detailed in accordance with the descriptive requirements of the law, it is to be understood that the details herein are to be interpreted as illustrative and not in a limiting sense.

What is claimed is:

1. An apparatus comprising;
a first member disposed coaxially to a second member;
a spring coiled around said members and engaging said members to transfer torque upon torque being applied in a first direction between said members and not engaging said members to not transfer torque upon torque being applied in a second direction between said members; said spring being constructed of a memory material that assumes either the engaging or non-engaging position upon reaching a predetermined temperature.

2. The apparatus of claim 1 wherein said spring is a cylindrical coil constructed of a shape memory alloy.

3. The apparatus of claim 2 wherein the shape memory alloy is Nitinol.

4. The apparatus of claim 1 further comprising an electrical circuit connected to said spring.

5. The apparatus of claim 4 wherein said first and second members are constructed from a non-conductive material.

6. The apparatus of claim 4 wherein said first and second members are electrically isolated from said spring.

7. The apparatus of claim 4 wherein said electrical circuit is used to change the temperature of said spring to said predetermined temperature.

8. The apparatus of claim 1 wherein said predetermined temperature may be achieved by a temperature change in the surrounding environment.

9. The apparatus of claim 1 wherein upon said spring reaching said predetermined temperature, said spring moves to the non-engaging or engaging position regardless of the direction of the applied torque.

10. The apparatus of claim 1 wherein said spring returns to either the engaging or nonengaging position upon the temperature of said spring cooling to a temperature lower than said predetermined temperature.

11. The apparatus of claim 1 wherein said spring temperature is controlled electrically.

12. A method of transferring torque between two shafts utilizing a wrap spring clutch having a spring constructed of a memory shape alloy, comprising the steps of:
rotating one of the shafts in a first direction to transfer torque to the other shaft; and
heating the spring to terminate the transfer of torque between the shafts.

13. The method of claim 12 wherein heat is applied to the spring through heat transfer from the surrounding environment.

14. The method of claim 12 wherein heat is applied to the spring by passing current through the spring.

15. The method of claim 12 further including cooling the spring to transfer torque between the shafts.

16. A valve apparatus comprising:
a valve housing having a closure member with an open and closed position, said closure member actuated between positions by a rotating member;
a wrap spring clutch assembly, having a spring constructed of shape memory alloy, disposed on a rotating allowing the rotating member to move the open position upon being heated to a predetermined temperature.

17. A method for closing a valve comprising:
maintaining the valve in an open position using a wrap spring clutch having a spring constructed of memory shape alloy; and
applying heat to the spring thereby causing the spring to change shape and allowing the valve to move to the closed position.

18. A wrap spring clutch having a spring constructed from a shape memory alloy.

19. The wrap spring clutch of claim 18 wherein the shape memory alloy is Nitinol.
